(19) United States
(12) Patent Application Publication
(10) Pub. No.: US 2019/0163734 A1
(43) Pub. Date: May 30, 2019

(54) DYNAMIC PATTERN RECOGNITION IN SPREADSHEETS

(71) Applicant: Microsoft Technology Licensing, LLC, Redmond, WA (US)

(72) Inventors: Eyal GABER, Moshav Bitsaron (IL); Nerya COHEN, Elkana (IL); Shani KABARITI, Herzeliya-Shenk (IL)

(21) Appl. No.: 15/823,202

(22) Filed: Nov. 27, 2017

(51) Int. Cl. G06F 17/24; G06F 3/023

(52) U.S. Cl. CPC G06F 17/246; G06F 3/0237

(57) ABSTRACT

A computing device and method for dynamic pattern recognition in a spreadsheet. The computing device comprises an electronic processor and a display device. The electronic processor executing instructions to receive a data set including a tabular sample input data and tabular sample output data, extract a pattern associated with the data set based on parameters in an autocomplete function, apply the pattern associated with the data set on a source data using the autocomplete function to determine a result data, and dynamically update the result data in response to a change in the source data and display the updated result data on the display device.

### FIELD

Embodiments described herein generally relate to electronic spreadsheets and more particularly to dynamically manipulating objects associated with tabular data.

### BACKGROUND

Spreadsheet applications have long been used to organize and manipulate sets of data, typically, but not limited to, numeric data. A spreadsheet is usually in a table form, having a grid of rows and columns of cells. Each cell usually represent one element of data. A cell can hold text data, numeric data, date/time data, and so forth. The value of a cell can be entered directly by a user, or can be entered using a function or as the result of a calculation or formula. Organizing data entered into the spreadsheet can often be tedious and/or challenging for a non-technical user because various formulae may be needed to manipulate the entered data. A measure of usefulness for a spreadsheet application depends on the variety of functions available and the ease of use of the function within the spreadsheet application. Currently, many functions are unavailable and unsupported by existing spreadsheet applications that makes organizing data entered into the spreadsheet more accessible and intuitive for the average user.

### SUMMARY

Spreadsheet applications provide several functions (for example, auto fill in Excel) for automatically entering data based on performing a cell match with an existing entry within a column. Some functions (for example, an autocomplete formula such as “Flash Fill”) recognize patterns in the data entered in a first column of a worksheet table and takes a part of the data in that column and enters just that data in a second column. However, when data in the first column is changed the data in the second column does not automatically change and as a result can lead to having the wrong data in the second column leading to further errors when this data is used in further calculations and processing.

The autocomplete function typically provides a static solution that calculates the pattern of a sample input data and generates output result data for the given set of input data. The output result data is calculated only once and it does not automatically get updated when the sample input data or the pattern associated with the sample input data is changed. This limitation is overcome by dynamically recalculating the pattern associated with the sample input data based on detecting a text manipulation or change in pattern associated with the sample input data. The deficiencies of the prior art are overcome by providing an integrated method embodied in computer software for use with a computer for dynamically recalculating and extracting patterns within a spreadsheet and performing an autocomplete function based on the extracted patterns. Systems and methods described herein provide for an improved spreadsheet application that allows for faster and more efficient way to dynamically enter data in a worksheet. The spreadsheet application can automatically detect changes in an input data and update the output data using an autocomplete function that uses the patterns associated with the changed input data. Additionally, the various embodiments provide a better user experience during the operation of a spreadsheet application.

For example, one embodiment provides a computing device including an electronic processor configured to data set including tabular sample input data and tabular sample output data, extract a pattern associated with the data set based on parameters in an autocomplete function, apply the pattern associated with the data set on source data using the autocomplete function to determine result data, and dynamically update the result data in response to a change in the source data. The computing device also includes a display device to display the updated result data.

Another embodiment provides for a method of receiving, with an editing surface of the spreadsheet, a data set including a tabular sample input data and tabular sample output data. The method also includes extracting, with a pattern extractor, a pattern associated with the data set. The method also includes applying the pattern associated with the data set on a source data using an autocomplete function to determine a result data. The method further includes dynamically updating the result data in response to a change in the source data; and displaying the updated result data.

Another embodiment provides for a non-transitory computer-readable medium storing instructions that, when executed with an electronic processor of a user device, perform a set of functions, the set of functions comprising receiving, with an editing surface of the spreadsheet, a data set including a tabular sample input data and tabular sample output data; extracting, with a pattern extractor, a pattern associated with the data set; applying the pattern associated with the data set on a source data using an autocomplete function to determine result data; dynamically updating the result data in response to a change in the source data; and displaying the updated result data.

Accordingly, embodiments described herein bring, among other things, the power of text manipulation to the hands of common, non-technical, everyday users. The foregoing is a non-limiting summary of features of various embodiments. It should be appreciated that the foregoing features may be used singly or in any suitable combination.

### BRIEF DESCRIPTION OF THE DRAWINGS

FIG. 1 illustrates a system for processing tabular data using a spreadsheet application, in accordance with some embodiments.

FIG. 2 illustrates a server included in the system of FIG. 1, in accordance with some embodiments.

FIG. 3 illustrates a user device included in the system of FIG. 1, in accordance with some embodiments.

FIG. 4 illustrates an editing surface of a spreadsheet capable of performing dynamic pattern recognition, in accordance with some embodiments.

FIG. 5A is an inter-process communication flow diagram showing an operation associated with a user activation of a Flash Fill formula, in accordance with some embodiments.

FIG. 5B is an inter-process communication flow diagram showing an operation associated with changing of the source data, in accordance with some embodiments.

FIG. 5C is an inter-process communication flow diagram showing an operation associated with changing the Flash Fill data set, in accordance with some embodiments.

FIG. 6 is a flow chart of a method for updating a spreadsheet based on dynamic pattern recognition, in accordance with some embodiments.

FIG. 7 illustrates an editing surface of a spreadsheet capable of performing dynamic pattern recognition, in accordance with some embodiments.

FIG. 8 illustrates the editing surface of the spreadsheet shown in FIG. 7 having an autocomplete function performed, in accordance with some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

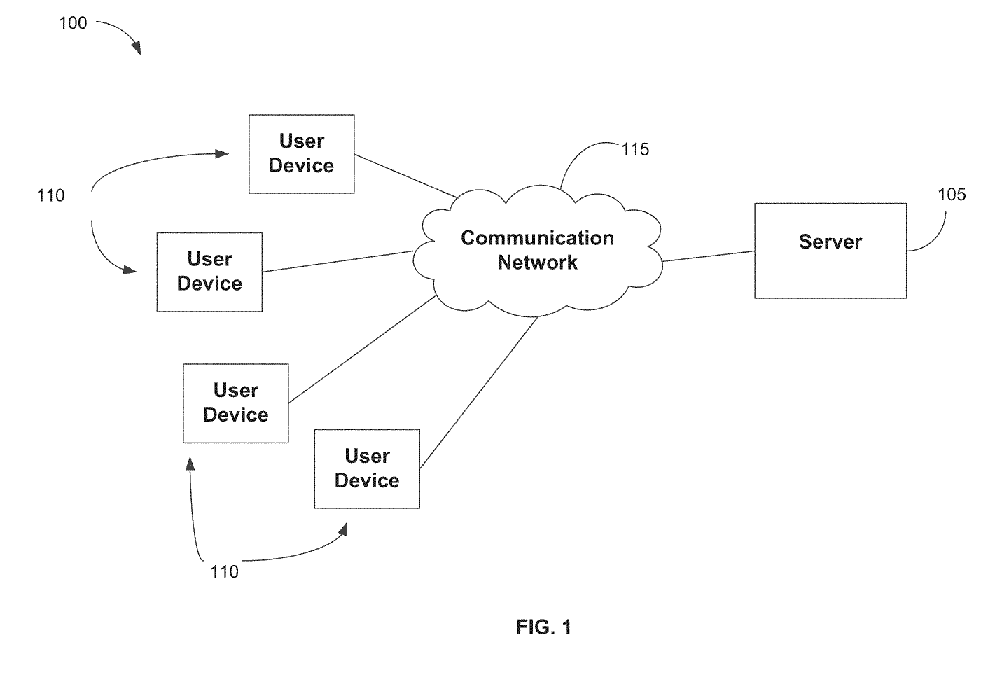

FIG. 1 schematically illustrates a system 100 for processing data using a spreadsheet application in accordance with some embodiments. As illustrated in FIG. 1, the system 100 includes a remote computer or server 105 and a plurality of user devices 110 (referred to herein collectively as “the plurality of user devices 110” and individually as “a user device 110”). The server 105 and the plurality of user devices 110 communicate over one or more wired or wireless communication networks 115. Portions of the wireless communication networks 115 may be implemented using a wide area network, such as the Internet, a local area network, such as a Bluetooth™ network or Wi-Fi, and combinations or derivatives thereof. In some embodiments, each of the plurality of user devices 110 is associated with a common domain, such as an enterprise. However, in other embodiments, the plurality of user devices 110 represent individual consumers unrelated to a common enterprise or sharing of a common local area network or the like. It should be understood that the server 105 may communicate with a different number of user devices 110 and the four user devices 110 that are illustrated in FIG. 1 are purely for explanatory purposes. Also, in some embodiments, a user device 110 communicates with the server 105 through one or more interim devices. The server 105 provides a means for processing the tabular data and determining information about the tabular data. It should be understood that the functionality described herein as being performed by the server 105 may be distributed among multiple devices, such as multiple servers operated within a cloud environment.

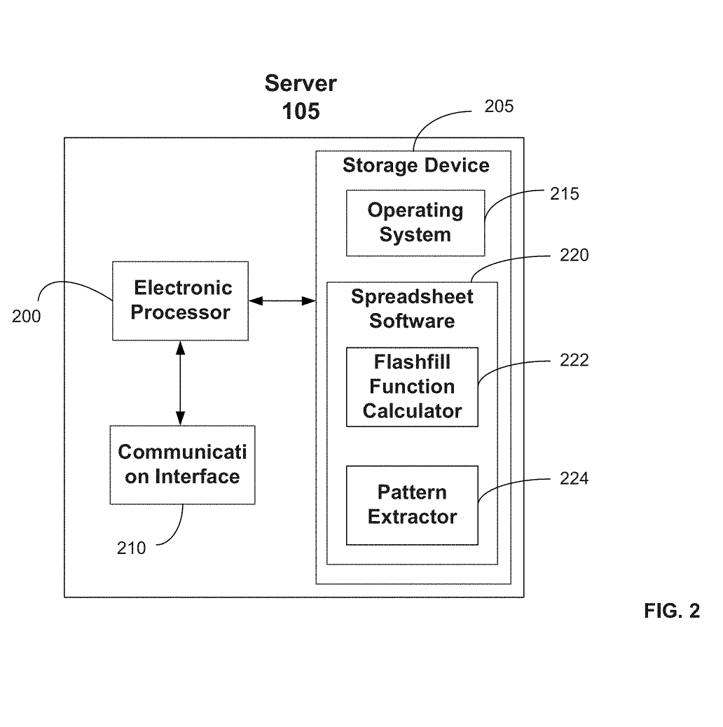

As illustrated in FIG. 2, the server 105 includes an electronic processor 200 (for example, a microprocessor, application-specific integrated circuit (ASIC), or another suitable electronic device), a storage device 205 (for example, a non-transitory, computer-readable storage medium), and a communication interface 210, such as a transceiver, for communicating over the communication network 115 and, optionally, one or more additional communication networks or connections. The electronic processor 200, the storage device 205, and the communication interface 210 communicate over one or more communication lines or buses. It should be understood that the server 105 may include additional components than those illustrated in FIG. 2 in various configurations and may perform additional functionality than the functionality described in the present application. For example, as noted above, in some embodiments, the functionality described herein as being performed by the server 105 is distributed among multiple devices, such as multiple servers operated within a cloud environment. The electronic processor 200 executes instructions stored in the storage device 205. In particular, as illustrated in FIG. 2, the storage device 205 stores the operating system software 215 and the spreadsheet software 220. An example of the operating system software 215 on which the spreadsheet software 220 is the Macintosh operating system b Apple Computer, Inc. In some instances, the spreadsheet software 220 is operated on different operating systems (for example, the Windows® operating system from Microsoft Corporation, the Linux operating system from Sun Microsystems, Inc. or the like). The spreadsheet software 220 is a software application, such as, for example, Excel® provided by Microsoft Corporation®, that is executable by the electronic processor 200.

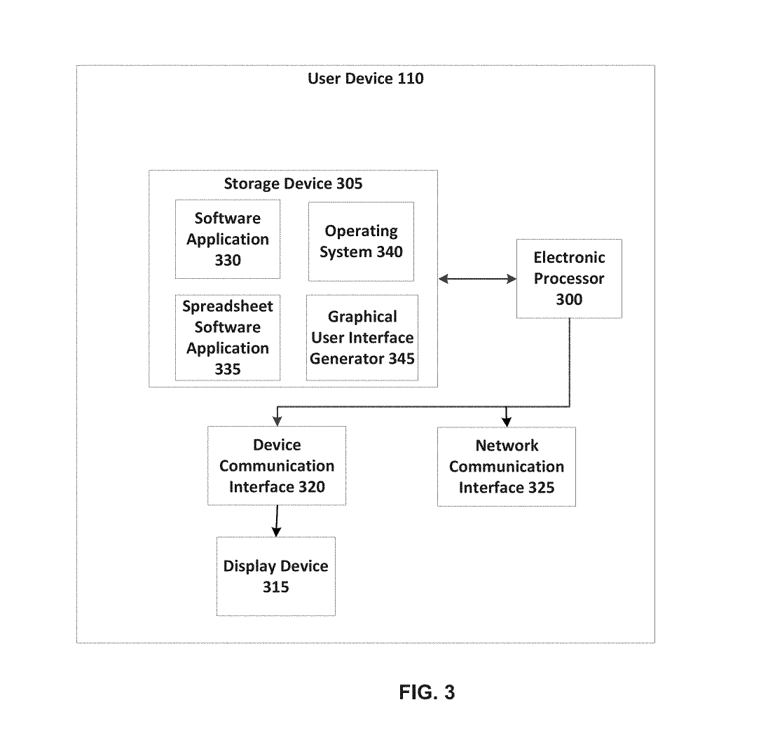

As illustrated in FIG. 3, a user device 110 includes an electronic processor 300 (for example, a microprocessor, application-specific integrated circuit (ASIC), or another suitable electronic device), a storage device 305 (for example, a non-transitory, computer-readable storage medium), a display device 315, a device communication interface 320, and a network communication interface 325 such as a transceiver, for communicating over the communication networks 115 and, optionally, one or more additional communication networks or connections. The electronic processor 300, the storage device 305, the device communication interface 320, and the network communication interface 325 communicate over one or more communication lines or buses. The display device 315 communicates with the electronic processor 300 via the device communication interface 320. It should be understood that a user device 110 may include additional components than those illustrated in FIG. 3 in various configurations and may perform additional functionality than the functionality described in the present application. For example, the user device 110 may perform the functionality described above as being performed by the server 105. In some embodiments, the user device 110 is a standalone computing device that can operate independent of server 105 to perform the functions described by the methods disclosed herein.

The storage device 305 stores a software application 330, a spreadsheet software application 335, an operating system 340, and a graphical user interface generator 345. The electronic processor 300 executes instructions stored in the software application 330, spreadsheet software application 335, operating system 340, and graphical user interface generator 345. The software application 330 also contains instructions that, upon receiving a user input, cause the information received from the server 105 to be sent to the spreadsheet software application 335.

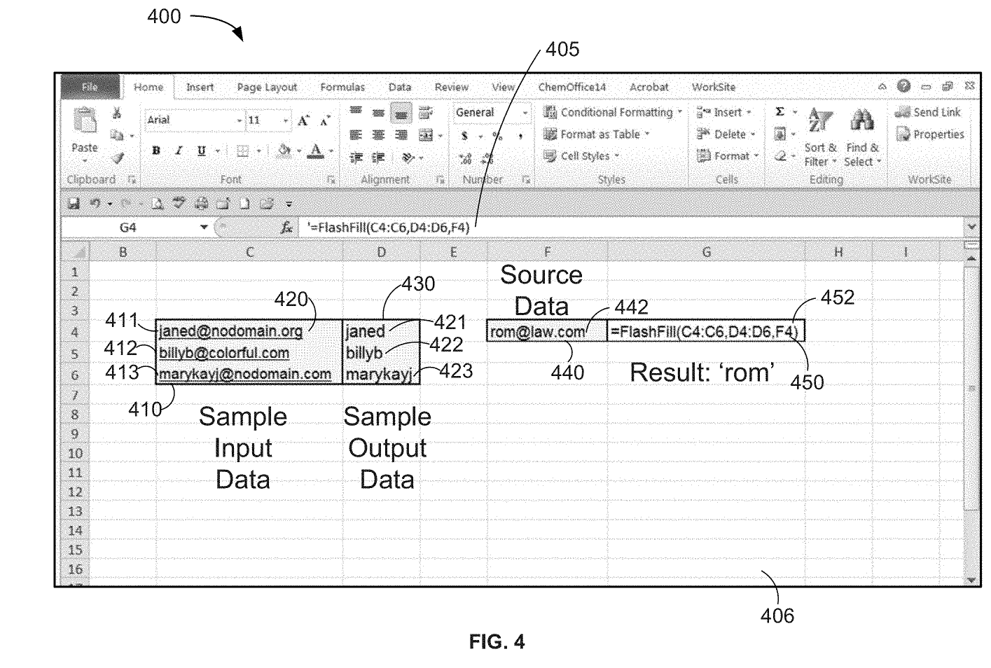

Upon launching the spreadsheet software application 335, a graphical user interface is presented on the display device 315, including an editing surface (shown in FIG. 4) for the spreadsheet to facilitate entering and managing information on the spreadsheet.

FIG. 4 illustrates an editing surface (for example, a graphical user interface) of spreadsheet 400 of a spreadsheet application capable of performing dynamic pattern recognition, in accordance with some embodiments. The editing surface of spreadsheet 400 includes a set of toolbars each of which implement a particular functionality. Such as, for example, font, alignment, style, page formatting, insertion of charts and tables, review/editing, etc. The editing surface of spreadsheet 400 includes rows and columns of individual cells. In one instance, the columns are organized by letter—Columns A, B, C, etc.—and the rows are organized by number—Rows 1, 2, 3, etc., although the column and row designations may be switched or represented otherwise in alternative embodiments. There may be more or less columns and rows than shown in FIG. 4. Each cell is identified by a combination of column letter and row number. Cell “B3,” for instance, may be in column B and row 3. In FIG. 4, columns of text and numbers are provided in columns A, D, and E. The characters in cells shown in FIG. 4 are used to illustrate the operation of the example provided, in other instances, the characters and position of the characters on the spreadsheet vary. The editing surface of spreadsheet 400 may be resized and moved around the display using windowing or similar techniques. The editing surface of spreadsheet 400 includes a formula bar 405 that is an editable area in which equations, text, or other data may be input for entry into the spreadsheet. The editing surface of spreadsheet 400 also includes a cell grid 406 including a plurality of individual cells that are capable of storing data. As shown in FIG. 4, the editing surface of spreadsheet 400 shows a data set 410 including a tabular sample input data 420 and a tabular sample output data 430. The tabular sample input data 420 lists an email address in each of the cells 411-413 (shown in C4-C6) and tabular sample output data 430 lists user identifiers in cells 421-423 (shown in cells D4-D6 of the spreadsheet) that are part of the email addresses listed in D4-D6. Also shown in FIG. 4 are source data 440 and result data 450. The source data 440 includes an email address entered into cell 442 (shown in F4 of the spreadsheet) and the result data 450 shows the output of a Flash Fill function 452 (shown in cell G4) as “=Flashfill(C4:C6,D4:D6, F4)”). Entry of the Flash Fill formula into a particular sell is set apart from entry of normal data by the use of a leading descriptor entry, such as an “=” sign.

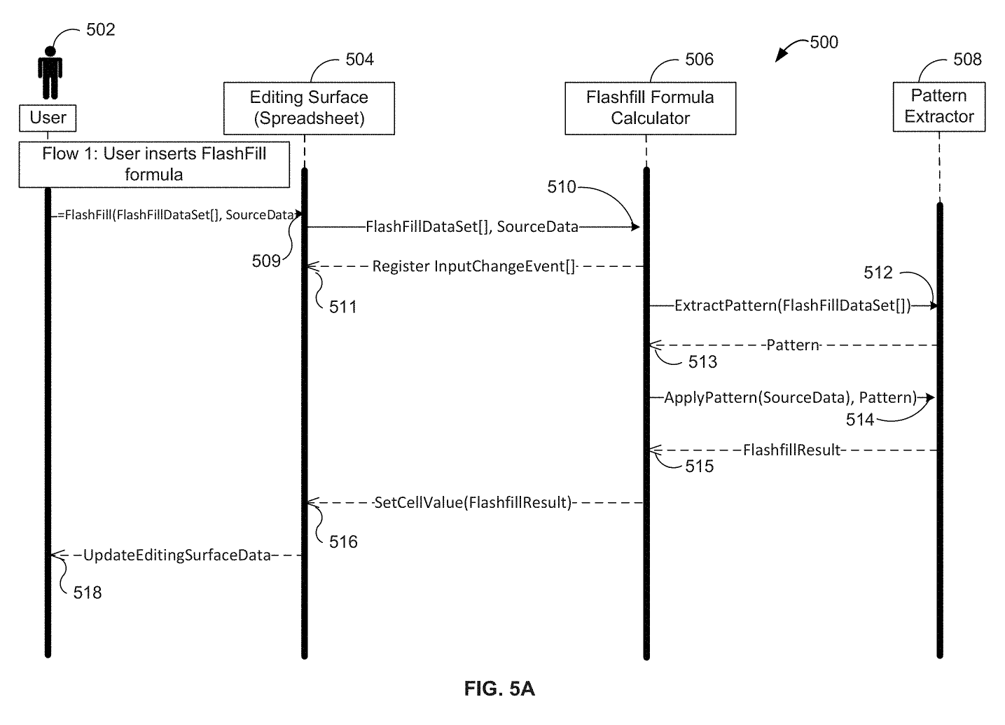

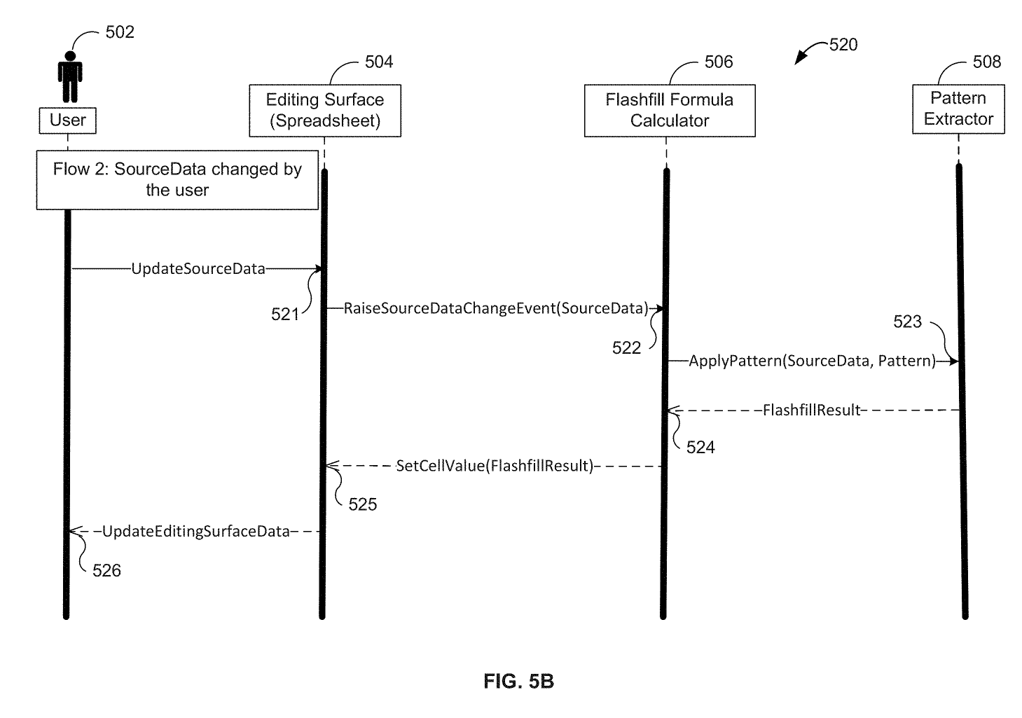

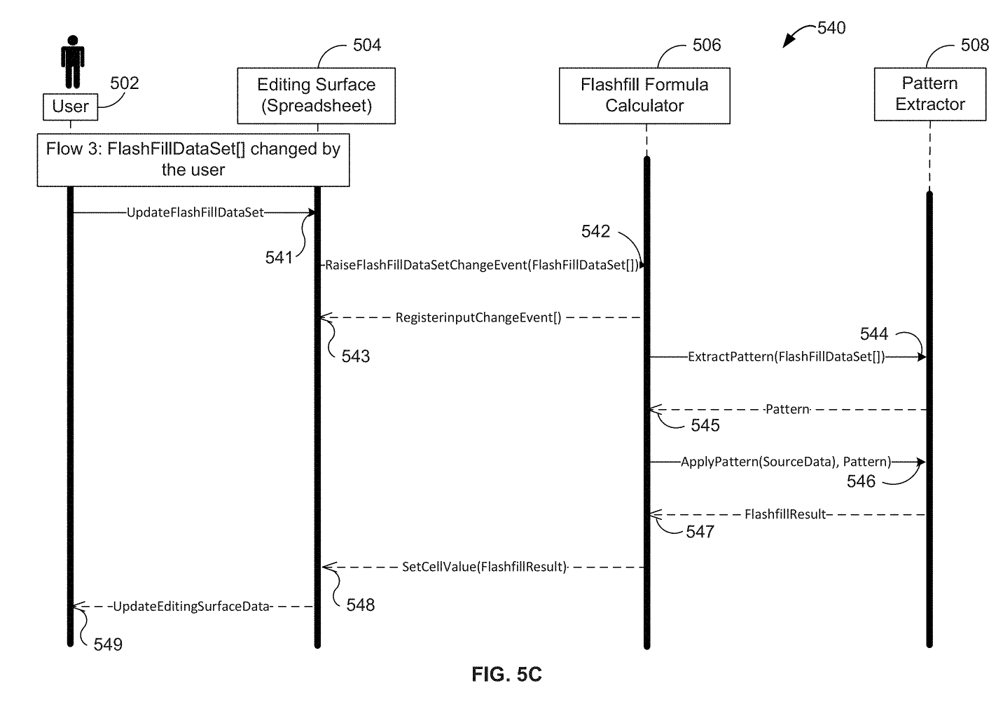

FIG. 5A is a flow diagram 500 showing an operation associated with a user activation of a Flash Fill formula, in accordance with some embodiments. In the example provided, a user 502, an editing surface 504, a Flash Fill formula calculator 506, and a pattern extractor 508 initiate calls and receive responses between each other as described below. In one example, the user 502 inserts a Flash Fill formula (for example, having a syntax “=Flashfill(FlashfillDataSet[ ], Source Data”) 509 using the editing surface 504. Upon receiving the Flash Fill formula, the editing surface 504 generates a call 510 to the Flash Fill formula calculator 506. The Flash Fill formula calculator 506 responds to the editing surface 504 using a register response 511. Additionally, the Flash Fill formula calculator 506 sends a call 512 to the pattern extractor 508 to extract a pattern within the received data set (for example, 410). The pattern extractor 508 sends a response 513 back to the Flash Fill formula calculator 506 with the extracted pattern. In some embodiments, the extracted pattern includes the particular arrangement of characters determined based on comparing the tabular sample input data 420 and the tabular sample output data 430.

Upon receiving the extracted pattern the Flash Fill formula calculator 506 applies the extracted pattern using call 514. The pattern extractor 508 sends a response 515 back to the Flash Fill formula calculator 506 with a Flash Fill result data having the extracted pattern. The Flash Fill formula calculator 506 further sends a response 516 to the editing surface 504 to store the Flash Fill result data in the cell (for example, G4 in FIG. 4) corresponding to the Flash Fill result data. The editing surface 504 is updated with the result data and a response 518 is provided to the user 502.

FIG. 5B is a flow diagram 520 showing an operation associated with changing of the source data in FIG. 5A, in accordance with some embodiments. As shown in FIG. 5B, as the user updates the source data, the editing surface receives the updated source data 521 and initiates a call 522, which is sent to Flash Fill formula calculator 506. The Flash Fill formula calculator 506 in turn sends a call 523 to the pattern extractor 508 to apply the pattern on the updated source data. Following which, the pattern extractor sends a response 524 back to Flash Fill formula calculator 506 with the updated Flash Fill result data. The Flash Fill formula calculator 506 sends a response 525 to the editing surface 504 to store the result data in the cell (for example, G4 in FIG. 4) corresponding to the result data. The editing surface 504 is updated with the updated Flash Fill result data and a response 526 is provided to the user 502.

FIG. 5C is a flow diagram 540 showing an operation associated with changing the Flash Fill data set in FIG. 5A, in accordance with some embodiments. In one example, the editing surface 504 receives updated data set 541. Upon receiving the updated data set 541, the editing surface 504 sends a call 542 to the Flash Fill formula calculator 506. The Flash Fill formula calculator 506 sends a response 543 back to the editing surface 504 acknowledging a change event associated with the updated data set 541. The Flash Fill formula calculator 506 sends a call 544 to the pattern extractor 508 to extract a pattern associated with the updated data set 541. The pattern extractor sends a response 545 back to the Flash Fill formula calculator 506 with a pattern associated with the updated data set 541. The Flash Fill formula calculator 506 then follows up with a call 546 requesting the pattern extractor 508 to apply the pattern associated with the updated data set 541 on the source data. The pattern extractor 508 sends response 547 to the Flash Fill formula calculator 506 with Flash Fill result data. The Flash Fill formula calculator 506 sends a response 548 to the editing surface 504 to store the updated Flash Fill result data in the cell (for example, G4 in FIG. 4) corresponding to the result data. The editing surface 504 is updated with the updated Flash Fill result data and a response 549 is provided to the user 502.

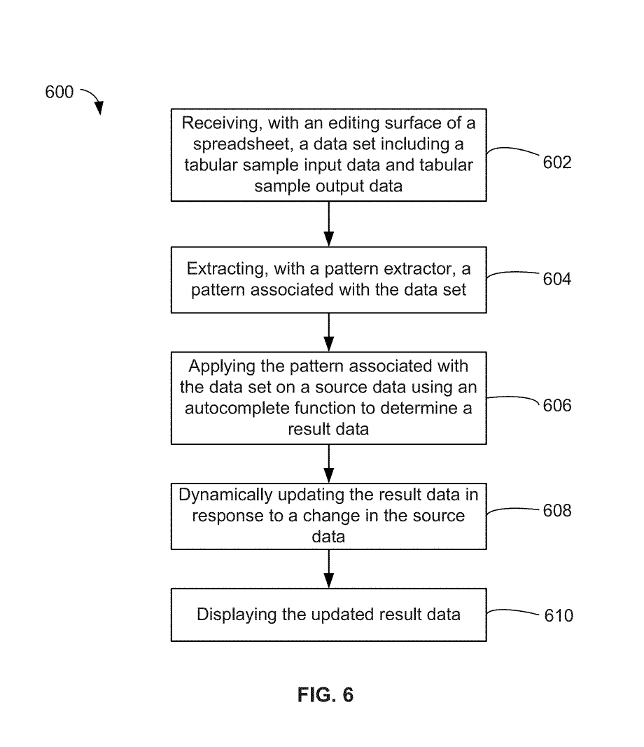

FIG. 6 is a flow chart of a method 600 for updating a spreadsheet based on dynamic pattern recognition, in accordance with some embodiments. At block 602, the method 600 includes receiving, with an editing surface 504 of a spreadsheet, a data set 410 including a tabular sample input data 420 and a tabular sample output data 430. In some embodiments, at block 602, a source data 440 that needs to be manipulated is also received. In some embodiments, receiving the data set 410 includes retrieving the data set 410 and source data 440 using a Flash Fill function (for example, Flashfill(FlashfillDataSet[ ], Source data)). For example, the data residing in cells C4, C5, and C6 along with data residing in cells D4, D5, and D6 and the source data 440 residing in F4 may be retrieved using the function “=Flashfill(C4:C6,D4:D6, F4)” as shown in FIG. 4.

At block 604, the method 600 includes extracting, with a pattern extractor 508, a pattern associated with the data set 410. In one example, extracting the pattern associated with the data set 410 includes comparing the entries in cells associated with the tabular sample input with the entries in cells associated with the tabular sample output. In the example shown in FIG. 4, the contents of the cells C4:C6 are compared to contents of the cells D4:D6. Upon performing the comparison, the Flash Fill function determines that the entries in the cells D4:D6 include characters of the email addresses in the cells C4:C6 that are listed before the “A” symbol. Essentially, the entries in the cells D4:D6 is a truncated portion of the email addresses listed in the cells C4:C6.

At block 606, the method 600 includes applying the pattern associated with the data set 410 on a source data 440 using a Flash Fill function 452 to determine a result data 450. In the example shown in FIG. 4, the Flash Fill function receives source data (rom@law.com) in the cell F4 and applies the pattern determined at block 604. Upon applying the pattern determined at block 604, the Flash Fill result is determined as “rom,” which is stored in the cell G4.

At block 608, the method 600 includes dynamically updating the Flash Fill result in response to a change in the source data. For example, if a change is performed on the source data in the cell F4 from “rom@law.com” to “project@experiment.com” then the Flash Fill result is updated to “project,” which will replace “rom,” the current entry in cell G4. At block 610, the method 600 includes displaying the updated Flash Fill result data on the display device 315. In some embodiments, the method 600 includes providing an indication that updated Flash Fill result data is being displayed.

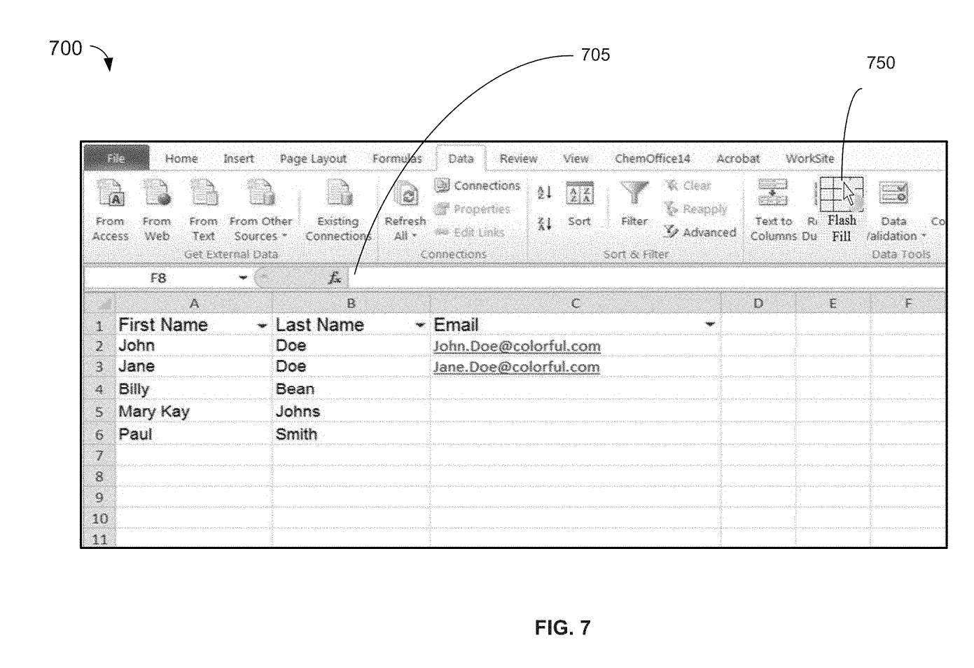

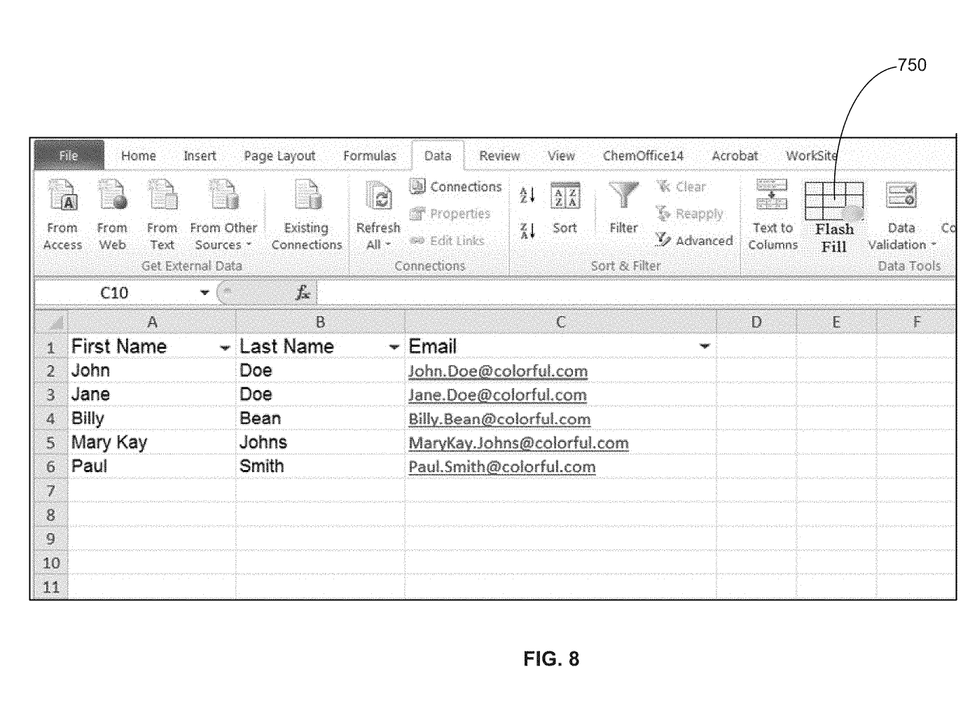

FIG. 7 illustrates an editing surface of a spreadsheet 700 capable of performing dynamic pattern recognition, in accordance with some embodiments. As described under FIG. 4, the editing surface of spreadsheet 700 includes rows and columns of individual cells. As shown in FIG. 7, Column A includes a listing of first names and column B includes a listing of last names corresponding to the first names listed in column A. Also, column C includes an incomplete list of email addresses associated with the names in column A & B. The user inputs into cell C2 the email address John.Doe@colorful.com. The user also inputs into cell C3 the email address Jane.Doe@colorful.com. In some embodiments, instead of inputting an email address into the cells C4, C5, and C6, the user selects the “Flash Fill” function to autocomplete the email address in the remaining cells C4, C5, and C6. FIG. 8 illustrates the editing surface of the spreadsheet shown in FIG. 7 having an autocomplete function performed for the cells that do not have an email address corresponding to the names listed in columns A and B, in accordance with some embodiments. In some embodiments, the cells that need to be autocompleted are selected before the “Flash Fill” function is selected. In some embodiments, the cells that require autocompletion are automatically selected for autocompletion using the “Flash Fill” function. In some embodiments, the “Flash Fill” function is configured to remove spaces between text strings within either the first name or the last name. For example, the first name “Mary Kay” in cell A5 is truncated into “MaryKay” when the email address is autocompleted in cell C5.

In some embodiments, the spreadsheet software is executed within the user device 110 and operates locally without communication with the server 105. In some embodiments, the spreadsheet software 220 described herein is executed by a server 105, and a user accesses and interacts with the spreadsheet software application 220 using a portable communication device. Also, in some embodiments, functionality provided by the spreadsheet software application as described above may be distributed between a software application executed by a user's portable communication device and a software application executed by another electronic process or device (for example, a server) external to the portable communication device. For example, a user can execute a spreadsheet software application (for example, a mobile application) installed on his or her smart device, which may be configured to communicate with another software application installed on a server.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

Thus, embodiments provide, among other things, computer device, systems and methods for dynamic pattern recognition in a spreadsheet. Various features and advantages of some embodiments are set forth in the following claims.

1. A computing device comprising:
an electronic processor configured to
receive a data set including a tabular sample input data and tabular sample output data;
extract a pattern associated with the data set based on parameters in an autocomplete function;
apply the pattern associated with the data set on a source data using the autocomplete function to determine a result data;
using the pattern, dynamically update the result data in response to a change in the source data; and
communicate the updated result data to a display device.

2. The computing device of claim 1, wherein the tabular sample output data including one or more characters associated with the tabular sample input data.

3. The computing device of claim 1, wherein the autocomplete function is executed using a autocomplete formula calculator.

4. The computing device of claim 3, wherein the autocomplete formula calculator is configured to retrieve the pattern from a pattern extractor.

5. The computing device of claim 4, wherein the pattern extractor is
configured to compare entries in a plurality of cells in the tabular sample input data with
entries in a plurality of corresponding cells in the tabular sample output data to determine the pattern.

6. The computing device of claim 1, wherein the electronic processor is further configured to
dynamically update the result data in response to a change in the tabular sample input data.

7. The computing device of claim 6, wherein the electronic processor is further configured to
extract a second pattern associated with the change in tabular sample input data.

8. The computing device of claim 1, wherein the electronic processor is further configured to
provide an indication that updated result data is being displayed.

9. A method for updating a spreadsheet based on dynamic pattern recognition, the method comprising:
receiving a data set including a tabular sample input data and tabular sample output data;
extracting, with a pattern extractor, a pattern associated with the data set;
applying the pattern associated with the data set on a source data using an autocomplete function to determine a result data;
using the pattern, dynamically updating the result data in response to a change in the source data; and
communicating the updated result data to a display device.

10. The method of claim 9, further comprising:
executing the autocomplete function with a autocomplete function calculator.

11. The method of claim 9, wherein receiving the data set includes
receiving the tabular sample output data including one or more characters associated with the tabular sample input data.

12. The method of claim 9, further comprising:
using parameters associated with the autocomplete function to select a portion of the tabular sample input data and the tabular sample output data and determine the pattern.

13. The method of claim 9, further comprising:
comparing entries in a plurality of cells in the tabular sample input data with entries in a plurality of corresponding cells in the tabular sample output data to determine the pattern.

14. The method of claim 9, further comprising:
dynamically updating the result data in response to a change in tabular sample input data.

15. The method of claim 14, further comprising:
extracting a second pattern associated with the change in the tabular sample input data.

16. The method of claim 9, further comprising:
providing an indication that updated result data is being displayed.

17. A non-transitory computer-readable medium storing instructions that, when executed with an electronic processor of a user device, perform a set of functions, the set of functions comprising:
receiving a data set including a tabular sample input data and tabular sample output data;
extracting, with a pattern extractor, a pattern associated with the data set;
applying the pattern associated with the data set on a source data using an autocomplete function to determine a result data;
using the pattern, dynamically updating the result data in response to a change in the source data; and
communicate the updated result data to a display device.

18. The non-transitory computer-readable medium of claim 17 storing instructions that, when executed with the electronic processor of the user device, perform the set of functions, wherein the set of functions further comprising:
using parameters associated with the autocomplete function to select a portion of the tabular sample input data and the tabular sample output data and determine the pattern.

19. The non-transitory computer-readable medium of claim 17, storing instructions that, when executed with the electronic processor of the user device, perform the set of functions, wherein the set of functions further comprising:
dynamically updating the result data in response to a change in the tabular sample input data.

20. The non-transitory computer-readable medium of claim 19, storing instructions that, when executed with the electronic processor of the user device, perform the set of functions, wherein the set of functions further comprising:
extracting a second pattern associated with the change in the tabular sample input data.
